(19) United States
(12) Patent Application Publication
(10) Pub. No.: US 2022/0414457 A1
(43) Pub. Date: Dec. 29, 2022

(54) SELECTIVE DATA STRUCTURE ENCODING FOR DEEP NEURAL NETWORK TRAINING

(71) Applicant: Microsoft Technology Licensing, LLC, Redmond, WA (US)

(72) Inventors: Fanny NINA PARAVECINO, San Jose, CA (US); Amar PHANISHAYEE, Seattle, WA (US); Atefeh MEHRABI, Durham, NC (US)

(21) Appl. No.: 17/362,751

(22) Filed: Jun. 29, 2021

(51) Int. Cl. G06N 3/08; G06N 3/04

(52) U.S. Cl. CPC G06N 3/08; G06N 3/04

(57) ABSTRACT

Methods, systems, apparatuses, and computer-readable storage mediums described herein are directed to techniques for efficient data encoding for neural network training. In particular, the embodiments described herein train a DNN based on a selective encoding (e.g., compressing) of data structures that are generated during training. For example, multiple training sessions may be performed where, in each training session, a different set of data structures performed by various operators of the DNN are encoded. Memory allocation information generated based on each training session is analyzed to determine which combination of encoded data structures results in a reduction of memory required to train the DNN.

### BACKGROUND

The availability of powerful computing resources has enabled a new breed of deep neural networks (“DNNs”) that are capable of solving previously intractable problems such as image classification, translation, and speech processing. These DNNs are trained by repeatedly iterating over datasets.

Widely used DNN training processes have large compute and memory requirements and, therefore, typically use accelerators (e.g., central processing units (CPUs), graphics processing units (GPUs), etc.) as their primary compute platform. However, as DNNs have grown larger and deeper, the size of available GPU main memory has become a significant bottleneck. This limits the size of DNNs that can be trained and, as a result, limits DNNs from solving even more complex problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are directed to techniques for efficient data encoding for neural network training. In particular, the embodiments described herein train a DNN based on a selective encoding (e.g., compressing) of data structures that are generated during training. For example, multiple training sessions may be performed where, in each training session, a different set of data structures generated by various operators of the DNN are encoded. Memory allocation information generated based on each training session is analyzed to determine which combination of encoded data structures results in a reduction of memory required to train the DNN.

Further features and advantages of the disclosed embodiments, as well as the structure and operation of various embodiments, are described in detail below with reference to the accompanying drawings. It is noted that the disclosed embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a system for efficient data structure encoding for deep neural network (DNN) training in accordance with an example embodiment.

FIG. 2 depicts a timing diagram illustrating how memory utilization during DNN training can be reduced in accordance with the embodiments described herein.

FIG. 3 is a block diagram of a system for efficient data structure encoding for deep neural network training in accordance with another example embodiment.

FIG. 4 depicts a graph illustrating the maximum memory allocation for a plurality of different training sessions in accordance with an example embodiment.

FIG. 5A depicts a graph illustrating the memory allocation for different combinations of encoded data structures generated by instances of a softmax operator in accordance with an example embodiment.

FIG. 5B depicts a graph illustrating the memory allocation for different combinations of encoded data structures generated by instances of an add operator in accordance with an example embodiment.

FIG. 5C depicts a graph illustrating the memory allocation for different combinations of encoded data structures generated by instances of a dropout operator in accordance with an example embodiment.

FIG. 5D depicts a graph illustrating the memory allocation for different combinations of encoded data structures generated by instances of a layer normalization operator in accordance with an example embodiment.

FIG. 6 depicts a flowchart of an example method for efficiently encoding data structures generated during deep neural network training in accordance with an example embodiment.

FIG. 7 depicts a flowchart of an example method for identifying a subset of identifiers in accordance with an example embodiment.

FIG. 8 is a block diagram of an exemplary user device in which embodiments may be implemented.

FIG. 9 is a block diagram of an example processor-based computer system that may be used to implement various embodiments.

The features and advantages of the disclosed embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

Artificial neural networks (ANNs) or connectionist systems are computing systems inspired by the biological neural networks that constitute animal brains. Such systems learn (progressively improve their ability) to do tasks by considering examples, generally without task-specific programming. An ANN is based on a collection of connected units called artificial neurons, (analogous to biological neurons in a biological brain). Each connection (synapse) between neurons can transmit a signal to another neuron. The receiving (postsynaptic) neuron can process the signal(s) and then signal downstream neurons connected to it. Neurons may have state, generally represented by real numbers, typically between 0 and 1. Neurons and synapses may also have a weight that varies as learning proceeds, which can increase or decrease the strength of the signal that it sends downstream. Typically, neurons are organized in layers. Different layers may perform different kinds of transformations on their inputs. Signals travel from the first (input), to the last (output) layer, possibly after traversing the layers multiple times.

A deep neural network (DNN) is an artificial neural network (ANN) with multiple layers between the input and output layers. There are different types of DNNs that include the components such as neurons, synapses, weights, biases, and functions. These components function similar to those of human brains and can be trained similarly to other machine learning (ML) algorithms. As described herein, a DNN generally consists of a sequence of layers of different types (e.g., a convolution layer, a rectified linear unit (ReLU) layer, a fully connected layer, pooling layers, etc.). DNNs used to process (e.g., categorize) images are typically trained using a labeled dataset (e.g., a set of images that have been labeled with data describing the content in the images). DNN training commonly utilizes an accelerator (e.g., one or more central processing units (CPUs), graphical processing units (GPUs), etc.) as the compute platform.

A DNN is trained across multiple epochs. In each epoch, the DNN trains over all of the training data in a training dataset in multiple steps. In each step, the DNN first makes a prediction for a subset of the training data, which is referred herein as a “minibatch” or a “batch.” Training on minibatches as opposed to training on individual instances of training data (e.g., individual images) has been shown to achieve better accuracy and better hardware utilization. This step is commonly referred to as a “forward pass” (which is also referred to herein as a “forward training pass”).

To make a prediction, input data from a minibatch is fed to the first layer of the DNN, which is commonly referred to as an “input layer.” Each layer of the DNN then computes a function over its inputs, often using learned parameters, or “weights,” to produce an input for the next layer. The output of the last layer, commonly referred to as the “output layer,” is a class prediction. Based on the label predicted by the DNN and the actual label of each instance of training data, the output layer computes a “loss,” or error function.

In a “backward pass” (which is also referred to herein as a “backward training pass”) of the DNN, each layer of the DNN computes the error for the previous layer and the gradients, or updates, to the weights of the layer that move the DNN's prediction toward the desired output. The result of training a DNN is a set of weights, or “kernels,” that represent a transform function that can be applied to an input with the result being a classification, or semantically labeled output.

The DNN training process described above has large compute and memory requirements. A large part of the memory required during DNN training is taken up by data structures (e.g., weights that change over the course of training, weight gradients, intermediate layer outputs or “feature maps” that need to be stored during a forward pass (referred to as “stash activations”) for use in the corresponding backward pass, and backward gradient maps).

A significant problem faced in recent DNN models is that, as the network gets deeper, the available accelerator's main memory becomes a primary bottleneck, limiting the size of networks it can train. There are a variety of methods that can improve performance in memory-intensive DNNs. Compressing stash activations is one popular approach that can be used to reduce memory footprint by reducing the bits representation on the feature maps. However, it remains a challenge to identify the most impactful stash activations to compress across different DNN models while not affecting the overall accuracy.

The embodiments disclosed herein address these and potentially other considerations. For example, embodiments described herein are directed to efficient data encoding for neural network training. In particular, the embodiments described herein train a DNN based on a selective encoding (e.g., compressing) of data structures that are generated during training. For example, multiple training sessions may be performed where, in each training session, a different set of stash activations performed by various operators of the DNN are encoded. Memory allocation information generated based on each training session is analyzed to determine which combination of encoded stash activations results in a reduction of memory required to train the DNN.

The disclosed embodiments reduce memory utilization during training of deep neural networks with minimal impact on performance. By reducing the memory footprint of DNNs during training, the embodiments described herein enable larger amounts of training (or batch) data to be stored in memory for use in training very deep networks. In addition, by selecting specific stash activations, higher memory savings may be obtained while also reducing the overhead cost of compression. Accordingly, the amount of processing cycles required to train a DNN is advantageously reduced.

It is noted that while the embodiments described herein describe techniques for efficient data encoding in a DNN, the techniques described herein may be applicable to other types of neural networks.

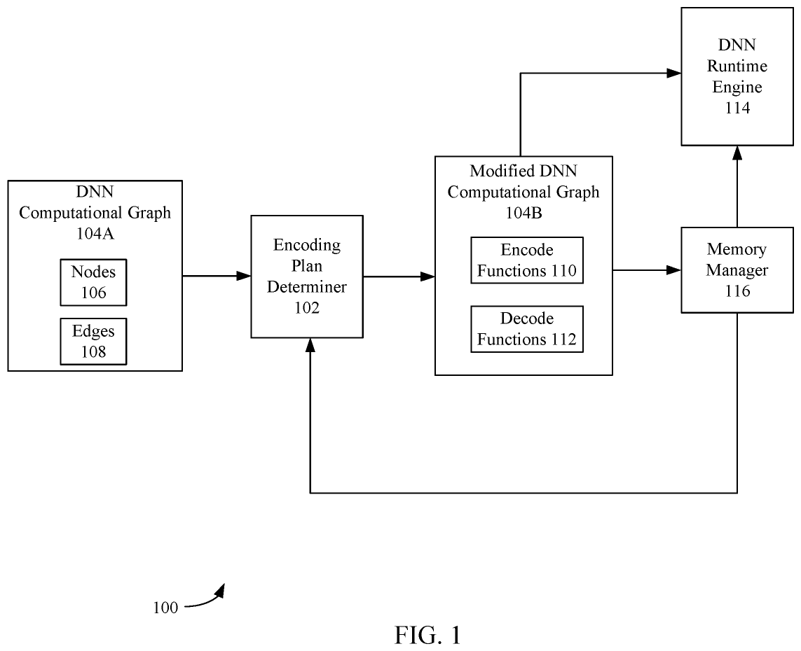

Embodiments may be implemented in a variety of systems. For instance, FIG. 1 is a block diagram of a system 100 configured for efficient data structure encoding for deep neural network training in accordance with an example embodiment. As shown in FIG. 1, system 100 comprises an encoding plan determiner 102, a DNN computational graph 104A, a modified DNN computational graph 104B, a DNN runtime engine 114, and a memory manager 116. System 100 is described in detail as follows.

DNN computational graph 104A comprises nodes 106 and edges 108 that define a DNN. Each of nodes 106 represent input values or operators (or functions) for combining values. Examples of operators include, but are not limited, to a softmax operator, a transpose operator, a reshape operator, an add operator, an expand operator, a dropout operator, or a layer normalization operator. Each of nodes 106 are connected to at least another node of nodes 106 via a respective edge of edges 108. Each of edges 108 represents a data dependency between operators that are represented by nodes of nodes 106 connected to the edge. Each of edges 108 may be directed edges. An edge of edges 108 that is incoming to a particular node of nodes 106 represents a flow of an input to that node (i.e., an input argument to the operator represented by the node). If all arguments required for an operator are available to the node, the node is enabled and executable. An edge of edges 108 that is outgoing from a particular node of nodes 106 represents a flow of an output of the operator represented by the node to be used as an input to an operator represented by another node of nodes 106. Thus, a directed edge of edges 108 connecting a first node of nodes 106 in DNN computational graph 104A to a second node of nodes 106 in DNN computational graph 104A indicates that an output generated by the operator represented by the first node is used as an input to the operator represented by the second node.

The input and outputs flowing along directed edges of edges 108 in the computational graph may be data structures, such as tensors. A tensor is a multidimensional array of numeric values or other values, e.g., strings, having a specific order that corresponds to the dimensionality of the array. For example, a scalar value is a 0th-order tensor, a vector of numeric values is a 1st-order tensor, and a matrix is a 2nd-order tensor. Examples of data structures include, but are not limited to, features maps, gradient maps, etc.

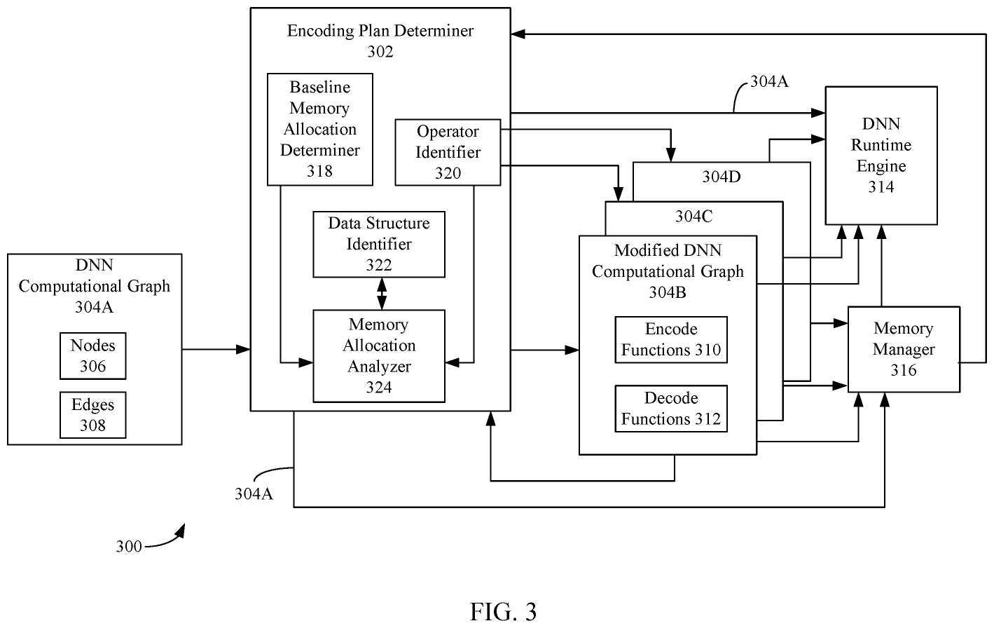

DNN computational graph 104A is provided to encoding plan determiner 102. Encoding plan determiner 102 is configured to identify which data structures (generated by the operators represented by nodes 106) are to be encoded. The type of data structures that are identified are data structures that are generated during a forward pass of the DNN and stored for use during a backward pass of the DNN (i.e., stash activations). To identify which data structures (or stash activations) are to be encoded, encoding plan determiner 102 causes a plurality of training sessions to be performed, where in each training session, a different combination of data structures is encoded. Encoding plan determiner 102 may utilize memory allocation information generated by memory manager 116 to determine the amount memory that is allocated for and/or during a particular training session. The combination of data structures that results in the lowest amount of memory allocation during a particular training session may be determined to be the combination of data structures that are to be encoded. Additional details regarding how encoding plan determiner 102 determines the combination of data structures that results in the lowest amount of memory allocation is described below with reference to FIG. 3.

After such data structures are identified, encoding plan determiner 102 generates modified DNN computation graph 104B by adding nodes 106, or other types of data, to original DNN computation graph 104A. The newly added nodes 106 may define encode functions 110 for encoding the identified data structures during a forward training pass of the DNN. Each of the newly added nodes 106 may be connected via an edge to a corresponding node representative of the operator that generates the data structure. Another edge may connect each of the newly added nodes 106 to a node representative of the operator that consumes the data structure. The newly-added nodes 106 may also define decode functions 112 for decoding the encoded data structures during a backward training pass of the DNN. Each of such newly added nodes 106 may be connected via an edge to a corresponding node that consumes the decoded data structure.

The type of encode functions and decode functions added to DNN computation graph 104A to generate modified DNN computation graph 104B may be selected based upon on the specific layer pairs defined by DNN computation graph 104A. For example, data structures generated via a ReLU layer and provided to a pooling layer may be encoded in accordance with a first lossless compression technique (e.g., a Binarize-based compression technique, where positive value maps are generated that represent the data structures via a 1-bit value). In another example, data structures generated via a ReLU layer and provided to a convolution layer during a forward pass may be encoded in accordance with a second lossless compression technique (e.g., a sparse storage and dense compute (SSDC)-based compression technique, where data structures are converted into a sparse data format). Data structures generated via a convolution layer and provided to a ReLU layer during a backward pass may decode the encoded data structure in accordance with a decompression technique that converts the data structures back into a sparse format. Data structures generated and consumed by other types of layers may utilize a lossy compression technique, such as, but not limited to a delayed precision reduction-based lossy compression technique.

Memory manager 116 is configured to analyze modified DNN computational graph 104B and determine the amount of memory to allocate during a training session of the DNN. The amount of memory to be allocated may be based on the number of operators of the DNN, the number of layers of the DNN, the size, data type, and/or lifetime of the data structures generated by the operators, etc.

DNN runtime engine 114 is configured to receive modified DNN computational graph 104B and perform the training session for the DNN in accordance with the determined amount of memory allocated by memory manager 116. During the training session, memory manager 116 allocates and deallocates memory as required by the various operators and monitors the maximum amount of memory that was allocated during the training session. Memory manager 116 may store such memory allocation information in a log file, which may be retrievable by encoding plan determiner 102. Alternatively, memory manager 116 may expose the memory allocation information via an application programming interface (API). Encoding plan determiner 102 may invoke the API to obtain the memory allocation information.

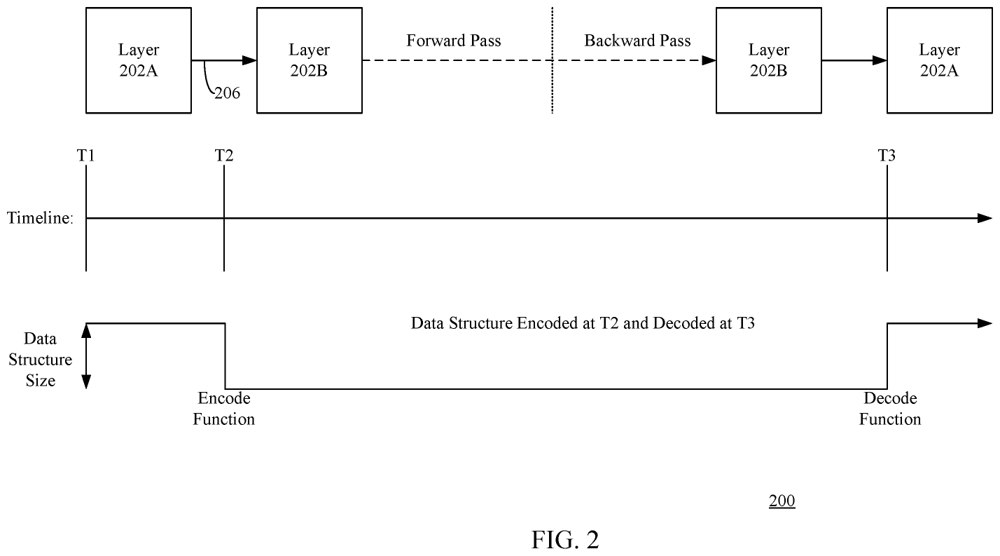

As will be described herein, the inclusion of encode functions 110 and decode functions 112 in modified DNN computation graph 104B can reduce the utilization of memory during training of the DNN. For example, FIG. 2 depicts a timing diagram 200 illustrating how memory utilization during DNN training can be reduced in accordance with the embodiments described herein. In the example shown in FIG. 2, a DNN includes at least two layers 202A and 202B. A forward training pass of the DNN begins at time T1, and a data structure 206 (e.g., an output feature map) is generated by layer 202A at time T2. Data structure 206 is then stored in memory for use during a backward training pass. Data structure 206 is not, however, utilized again until time T3 during the backward training pass. As a result, memory is utilized for storing the data structure 206 from time T2 until time T3 even though the data structure 206 is not used during that time period.

In accordance with the embodiments described herein, the amount of memory utilized between time T2 and time T3 can be reduced. In particular, data structure 206 can be retained in its original format as long as it is needed for the immediate forward use by layer 202B. Data structure 206 may then be encoded and stored for use during the backward training pass of the DNN. The original data structure can then be discarded. The encoded data structure is then decoded when it is needed for the backward training pass (i.e., at time T3 in the example shown in FIG. 2).

As will be described in greater detail below, certain data structures 206 utilized during training of a DNN, such as input and output features maps, can be stored using efficient encodings between the time they are no longer needed during the forward training pass until the time they are needed during the backward training pass. Moreover, if layer types and interactions are considered as described above, highly efficient layer-specific encodings can be utilized, thereby saving additional memory during DNN training.

FIG. 3 is a block diagram of a system 300 for efficient data structure encoding for deep neural network training in accordance with another example embodiment. As shown in FIG. 3, system 300 comprises an encoding plan determiner 302, a DNN computational graph 304A, modified DNN computational graphs 304B, 304C, and 304D, a DNN runtime engine 314, and a memory manager 316. Encoding plan determiner 302, DNN computational graph 304A, modified DNN computational graphs 304B, 304C, and 304D, DNN runtime engine 314, and memory manager 316 are respective examples of encoding plan determiner 102, DNN computational graph 104A, modified DNN computational graph 104B, DNN runtime engine 114, and memory manager 116, as described above with reference to FIG. 1. DNN computational graph 304A comprises nodes 306 and edges 308, which are examples of nodes 106, and edges 108, as described above with reference to FIG. 1. As also shown in FIG. 3, encoding plan determiner 302 comprises a baseline memory allocation determiner 318, an operator identifier 320, a data structure identifier 322, and a memory allocation analyzer 324.

Baseline memory allocation determiner 318 is configured to determine the amount of memory allocated for a training session of the DNN when no data structures generated by operators are encoded. For instance, baseline memory allocation determiner 318 may provide DNN computational graph 304A to memory manager 316 and DNN runtime engine 314. Memory manager 316 is configured to analyze DNN computational graph 304A and determine the amount of memory to allocate during a training session of the DNN when no data structures have been encoded. The amount of memory to be allocated may be based on the number of operators of the DNN, the number of layers of the DNN, the size, data type, and/or lifetime of the data structures generated by the operators, etc.

DNN runtime engine 314 is configured to receive DNN computational graph 304A and perform the training session for the DNN in accordance with the determined amount of memory allocated by memory manager 316. DNN runtime engine 314 may perform a single iteration of the training session based on DNN computation graph 304A and the memory allocation information provided by memory manager 316. During the training session, memory manager 316 allocates and deallocates memory as required by the various operators specified by nodes 306 and monitors the maximum amount of memory that was allocated during the training session (referred herein as the baseline memory allocation).

After completion of the training session, baseline memory allocation determiner 318 receives the memory allocation information (e.g., via retrieving a log comprising such information or via an API of memory manager 316) and determines the maximum amount of memory that was allocated during the training session for the DNN as a result of no data structures being encoded.

Operator identifier 320 is configured to determine which operators of the DNN generate data structures, that when encoded, have the most impact in terms of memory footprint reduction. For instance, for each operator of the DNN, operator identifier 320 may cause each data structure generated by the operator during a forward pass of the DNN and stored by the operator for use during a backward pass of the DNN (i.e., each stash activation) to be encoded. For instance, operator identifier 320 generates a respective modified DNN computation graph 304B by adding nodes 306 to original DNN computation graph 304A. The newly added nodes 306 may define encode functions 310 for encoding the identified data structures during a forward training pass of the DNN. The newly-added nodes 306 may also define decode functions 312 for decoding the encoded data structures during a backward training pass of the DNN. As described above, the type of encode functions and decode functions added to DNN computation graph 304A to generate the modified DNN computation graph 304B may be selected based upon on the specific layer pairs defined by DNN computation graph 304A.

Each generated modified DNN computational graph 304B is provided to memory manager 316 and DNN runtime engine 314. Memory manager 316 is configured to analyze each modified DNN computational graph 304B and determine the amount of memory to allocate during a training session of the DNN in accordance with the added encode functions 310 and decode functions 312.

DNN runtime engine 314 is configured to receive each modified DNN computational graph 304B and perform a training session for the DNN based on each modified DNN computational graph 304B in accordance with the determined amount of memory allocated by memory manager 316. DNN runtime engine 314 may perform a single iteration for each training session based on a respective modified DNN computation graph 304B and respective memory allocation information provided by memory manager 316. During the training session, memory manager 316 allocates and deallocates memory as required by the various operators specified by nodes 306 of the respective modified DNN computational graph 304B and monitors the maximum amount of memory that was allocated during the training session. After completion of the training session, operator identifier 320 receives the memory allocation information and determines the maximum amount of memory was allocated during the training session of the DNN.

After performing a training session for each operator, memory allocation analyzer 324 compares the amount of memory allocated during each of the training sessions to the memory baseline allocation determined by baseline memory allocation determiner 318. Memory allocation analyzer 324 is configured to determine whether the maximum amount of memory allocated during a particular training session is lower than the memory baseline allocation. If a determination is made that the amount of memory allocated during the particular training session is lower than the memory baseline allocation, then memory allocation analyzer 324 determines that encoding data structures for the particular operator for which that training session was performed has a significant impact in terms of memory footprint reduction.

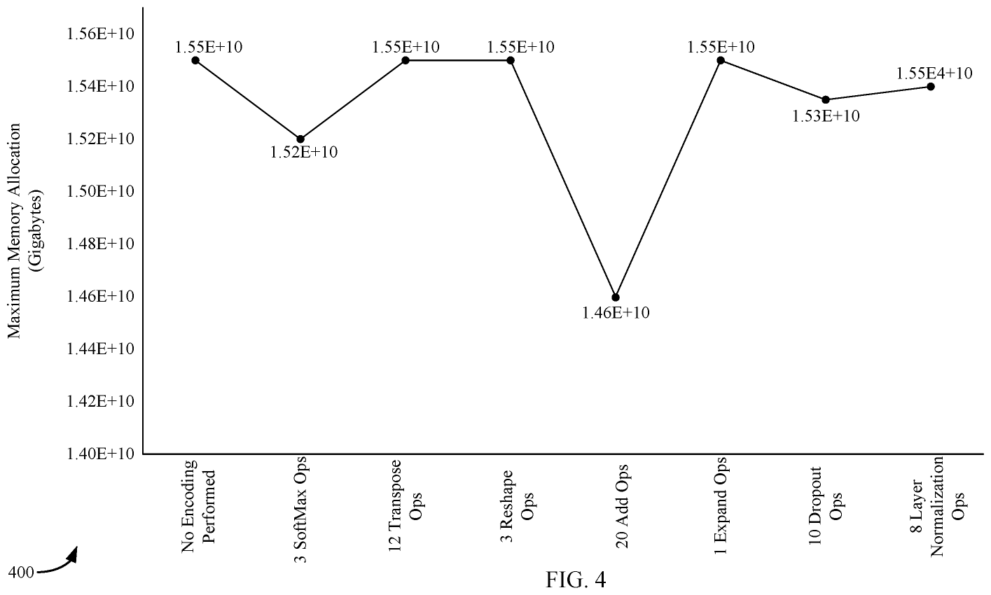

For example, FIG. 4 depicts a graph 400 illustrating the maximum memory allocation for a plurality of different training sessions in accordance with an example embodiment. In the example, shown in FIG. 4, eight training sessions were performed. In the first training session, no data structures were encoded. In the second training session, the data structures generated by instances of the softmax operator (e.g., three data structures) were encoded. In the third training session, the data structures generated by instances of the transpose operator (e.g., twelve data structures) were encoded. In the fourth training session, the data structures generated by instances of the reshape operator (three data structures) were encoded. In the fifth training session, data structures generated by instances of the add operator (twenty data structures) were encoded. In the sixth training session, the data structures generated by instances of the expand operator (one data structure) was encoded. In the seventh training session, data structures generated by instances of the dropout operator (ten data structures) were encoded. In the eighth training session, data structures generated by instances of the layer normalization operator (eight data structures) were encoded. As shown in FIG. 4, the amount of memory allocated during the first training session is the memory baseline allocation. Each of second, fifth, seventh and eighth training sessions resulted in a memory allocation that was lower than the memory baseline allocation. Accordingly, in this example, memory allocation analyzer 324 determines that encoding data structures for the softmax operator, the add operator, the dropout operator, and the layer normalization operator have a significant impact in terms of memory footprint reduction, and encoding data structures generated by instances of the transpose operator, the reshape operator, the expand operator, and the layer normalization operator do not have a significant impact in terms of memory footprint reduction.

Referring again to FIG. 3, data structure identifier 322 is configured to determine, for each operator identified by operator identifier 320, which data structures generated by that identified operator, when encoded, have a significant impact in terms of memory footprint reduction. For instance, for each operator identified by operator identifier 320, data structure identifier 322 may initiate multiple training sessions, where in each training session, a different combination of data structures generated by the identified operator are encoded. For instance, in a first training session, data structure identifier 322 may cause the first data structure generated by an instance of the operator to be encoded. In a second training session, data structure identifier 322 may cause the first and second data structures generated by respective instances of the operator to be encoded. In a third training session, data structure identifier 322 may cause the first, second, and third data structures generated by respective instances of the operator to be encoded. In a fourth training session, data structure identifier 322 may cause the second and third data structures (and not the first data structure) generated by respective instances of the operator to be encoded. In a fifth training session, data structure identifier 322 may only cause the second data structure (and not the first data structure) to be encoded, and so on and so forth.

For a given training session, data structure identifier 322 may cause a respective combination of data structures generated by instances of the operator during a forward pass of the DNN and stored by instances operator for use during a backward pass of the DNN to be encoded. For instance, data structure identifier 322 generates modified DNN computation graph 304C by adding nodes 306 to original DNN computation graph 304A. The newly added nodes 306 may define encode functions 310 for encoding a particular combination of data structures during a forward training pass of the DNN. The newly-added nodes 306 may also define decode functions 312 for decoding the encoded data structures during a backward training pass of the DNN. As described above, the type of encode functions and decode functions added to DNN computation graph 304A to generate modified DNN computation graph 304C may be selected based upon on the specific layer pairs defined by DNN computation graph 304A.

Modified DNN computational graph 304C generated for the given training session is provided to memory manager 316 and DNN runtime engine 314. Memory manager 316 is configured to analyze modified DNN computational graph 304C and determine the amount of memory to allocate during the given training session of the DNN in accordance with the added encode functions 310 and decode functions 312. DNN runtime engine 314 is configured to receive modified DNN computational graph 304C generated for the given training session and perform the training session for the DNN in accordance with the determined amount of memory allocated by memory manager 316. For each combination, DNN runtime engine 314 may perform a single iteration of the training session based on the respective modified DNN computation graph 304C and the memory allocation information provided by memory manager 316.

During the training session, memory manager 316 allocates and deallocates memory as required by the various operators specified by nodes 306 of the respective modified DNN computational graph 304C and monitors the maximum amount of memory that was allocated during the training session. After completion of the training session, data structure identifier 322 receives the memory allocation information (e.g., either via a log file generated by memory manager 316 or an API of memory manager 316) and determines how much memory was allocated during the training session for the DNN.

DNN runtime engine 314 performs the foregoing operations for each of the multiple training sessions. After completion of the multiple training sessions, memory allocation analyzer 324 compares the amount of memory allocated during each of the training sessions to the memory baseline allocation and determines which combination of encoded data structures resulted in an allocation of memory that is lower than the memory baseline allocation. In accordance with an embodiment, memory allocation analyzer 324 determines which combination of encoded data structures for the particular operator resulted in the lowest amount of memory allocated.

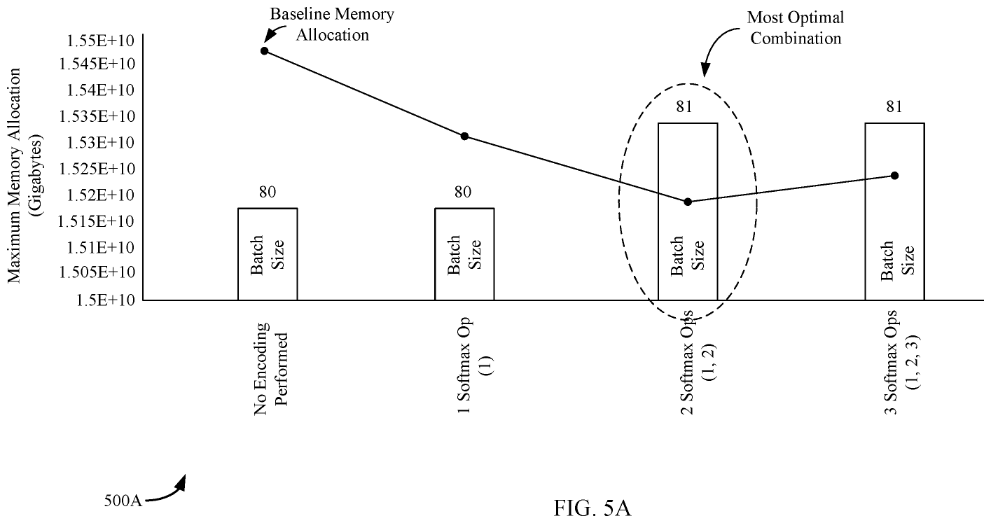

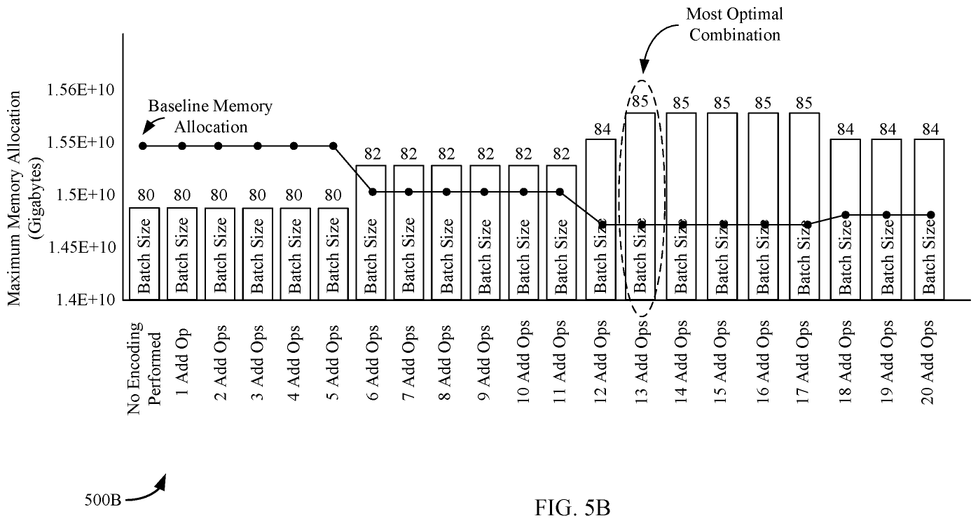

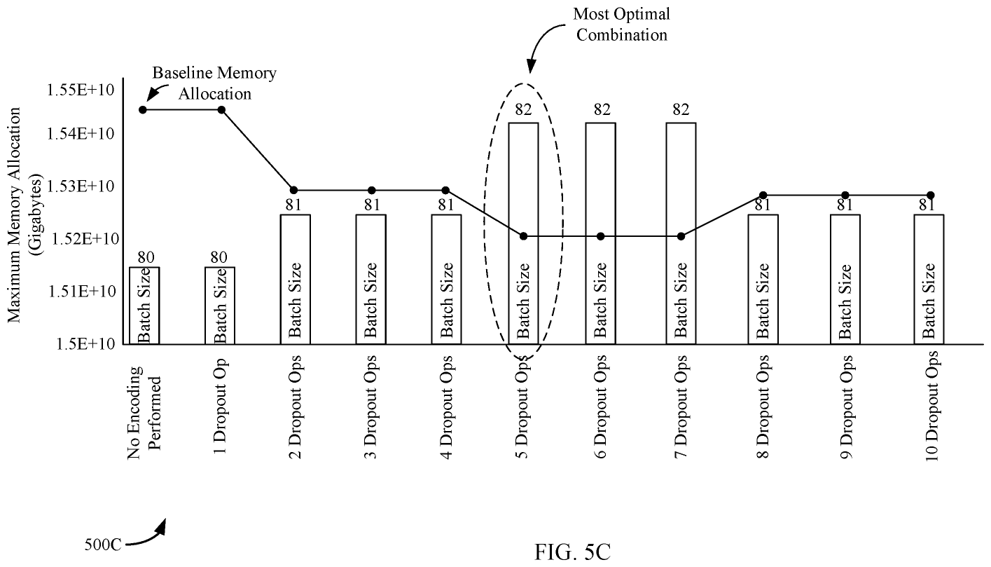

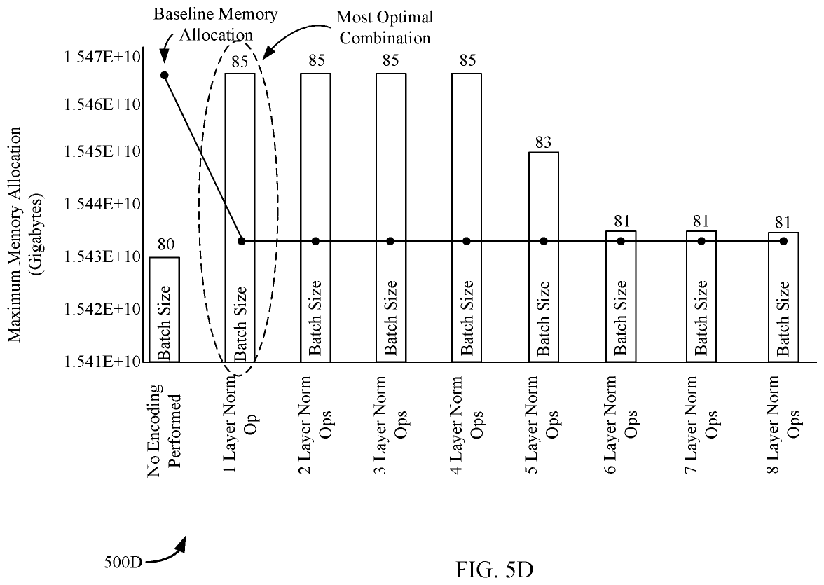

For example, FIGS. 5A-5D depict graphs 500A-500D, each illustrating the memory allocation for different combinations of encoded data structures for different operators in accordance with examples embodiments. In particular, FIG. 5A depicts graph 500A illustrating the memory allocation for different combinations of encoded data structures for instances of a softmax operator. FIG. 5B depicts graph 500B illustrating the memory allocation for different combinations of encoded data structures for instances of an add operator. FIG. 5C depicts graph 500C illustrating the memory allocation for different combinations of encoded data structures for instances of a dropout operator. FIG. 5D depicts graph 500D illustrating the memory allocation for different combinations of encoded data structures for instances of a layer normalization operator.

In the example shown in FIG. 5A, the DNN performs three softmax operations during a training session, where the first softmax operation is performed (e.g., in a first layer of the DNN), the second softmax operation is performed after the first softmax operation (e.g., in a second layer of the DNN), and the third softmax operation is performed after the second softmax operation (e.g., in a third layer of the DNN). In the first training session, only the data structure generated by the first instance of the softmax operator is encoded. In the second training session, only the data structures generated by the first and second instances of the softmax operator are encoded. In the third second training session, the data structures generated by the first, second, and third instances of the softmax operator are encoded. Memory allocation analyzer 324 analyzes the maximum memory allocated for each of the three training sessions and compares it to the baseline memory allocation to determine which combination of encoded data structures resulted in an allocation of memory that is lower than the memory baseline allocation. In accordance with an embodiment, memory allocation analyzer 324 identifies the minimum number of data structures generated by the softmax operator to encode to achieve the highest impact in terms of memory allocation and also enables a larger batch size. In the example shown in FIG. 5A, memory allocation analyzer 324 determines that encoding the first and second data structures generated by instances of softmax operators achieves the highest impact (i.e., the lowest memory footprint and enables a larger batch size). In fact, encoding the third data structure generated by an instance of the softmax operator would result in a higher memory footprint.

In the example shown in FIG. 5B, the DNN performs twenty add operations (which are performed sequentially). In the first training session, only the data structure generated by the first instance of the add operator is encoded. In the second training session, only the data structures generated by the first and second instances of the add operator are encoded. In the third training session, only the data structures generated by the first, second, and third instances of the add operator are encoded. In the fourth training session, only the data structures generated by the first through fourth instances of the add operator are encoded. In the fifth training session, only the data structures generated by the first through fifth instances of the add operator are encoded. In the sixth training session, only the data structures generated by the first through sixth instances of the add operator are encoded. In the seventh training session, only the data structures generated by the first through seventh instances of the add operator are encoded. In the eighth training session, only the data structures generated by the first through eighth instances of the add operator are encoded. In the ninth training session, the data structures generated by the first through ninth instances of the add operation are encoded. In the tenth training session, only the data structures generated by the first through tenth instances of the add operation are encoded. In the eleventh training session, only the data structures generated by the first through eleventh instances of the add operation are encoded. In the twelfth training session, only the data structures generated by the first through twelfth instances of the add operation are encoded. In the thirteenth training session, only the data structures generated by the first through thirteenth instances of the add operator are encoded. In the fourteenth training session, only the data structures generated by the first through fourteenth instances of the add operator are encoded. In the fifteenth training session, only the data structures generated by the first through fifteenth instances of the add operator are encoded. In the sixteenth training session, only the data structures generated by the first through sixteenth instances of the add operator are encoded. In the seventeenth training session, only the data structures generated by the first through seventeenth instances of the add operator are encoded. In the eighteenth training session, only the data structures generated by the first through eighteenth instances of the add operator are encoded. In the nineteenth training session, only the data structures generated by the first through nineteenth instances of the add operator are encoded. In the twentieth training session, the data structures generated by the first through twentieth instances of the add operator are encoded.

Memory allocation analyzer 324 analyzes the maximum memory allocated for each of the twenty training sessions and compares it to the baseline memory allocation to determine which combination of encoded data structures resulted in an allocation of memory that is lower than the memory baseline allocation. In accordance with an embodiment, memory allocation analyzer 324 identifies the minimum number of data structures generated by the add operator to encode that achieves the highest impact in terms of memory allocation and also enables a largest batch size. In the example shown in FIG. 5B, memory allocation analyzer 324 determines that encoding the data structures generated by the first thirteen instances of the add operator achieves the highest impact (i.e., the lowest memory footprint and enables the largest batch size). Encoding any data structures generated by additional instances of the add operation would not provide any performance again, and in certain instances, may even result in an increase in the memory footprint and a lower batch size.

In the example shown in FIG. 5C, the DNN performs ten dropout operations (which are performed sequentially). In the first training session, only the data structure generated by the first instance of the dropout operator is encoded. In the second training session, only the data structures generated by the first and second instances of the dropout operator are encoded. In the third training session, only the data structures generated by the first, second, and third instances dropout operator are encoded. In the fourth training session, only the data structures generated by the first through fourth instances of the dropout operator are encoded. In the fifth training session, only the data structures generated by the first through fifth instances of the dropout operator are encoded. In the sixth training session, only the data structures generated by the first through sixth instances of the dropout operator are encoded. In the seventh training session, only the data structures generated by the first through seventh instances of the dropout operator are encoded. In the eighth training session, only the data structures generated by the first through eighth instances of the dropout operator are encoded. In the ninth training session, only the data structures generated by the first through ninth instances of the dropout operation are encoded. In the tenth training session, only the data structures generated by the first through tenth instances of the dropout operation are encoded.

Memory allocation analyzer 324 analyzes the maximum memory allocated for each of the ten training sessions and compares it to the baseline memory allocation to determine which combination of encoded data structures resulted in an allocation of memory that is lower than the memory baseline allocation. In accordance with an embodiment, memory allocation analyzer 324 identifies the minimum number of data structures generated by the dropout operator to encode that achieves the highest impact in terms of memory allocation and also enables a largest batch size. In the example shown in FIG. 5C, memory allocation analyzer 324 determines that encoding the data structures generated by the first five instances of the dropout operator achieves the highest impact (i.e., the lowest memory footprint and enables the largest batch size). Encoding any data structures generated by additional instances of the dropout operation would not provide any performance again, and in certain instances, may even result in an increase in the memory footprint and a lower batch size.

In the example shown in FIG. 5D, the DNN performs eight layer normalization operations (which are sequentially performed). In the first training session, only the data structure generated by the first instance of the layer normalization operator is encoded. In the second training session, only the data structures generated by the first and second instances of the layer normalization operator are encoded. In the third second training session, only the data structures generated by the first, second, and third instances dropout layer normalization are encoded. In the fourth training session, only the data structures generated by the first through fourth instances of the layer normalization operator are encoded. In the fifth training session, only the data structures generated by the first through fifth instances of the layer normalization operator are encoded. In the sixth training session, only the data structures generated by the first through sixth instances of the layer normalization operator are encoded. In the seventh training session, only the data structures generated by the first through seventh instances of the layer normalization operator are encoded. In the eighth training session, the data structures generated by the first through eighth instances of the layer normalization operator are encoded.

Memory allocation analyzer 324 analyzes the maximum memory allocated for each of the eight training sessions and compares it to the baseline memory allocation to determine which combination of encoded data structures resulted in an allocation of memory that is lower than the memory baseline allocation. In accordance with an embodiment, memory allocation analyzer 324 identifies the minimum number of data structures generated by the layer normalization operator to encode, which achieves the highest impact in terms of memory allocation and also enables a largest batch size. In the example shown in FIG. 5D, memory allocation analyzer 324 determines that encoding the data structure generated by the first instance of the dropout operator achieves the highest impact (i.e., the lowest memory footprint and enables the largest batch size). Encoding any data structures generated by additional instances of the layer normalization operation would not provide any performance again, and in certain instances, may even result in an increase in the memory footprint and a lower batch size.

Referring again to FIG. 3, memory allocation analyzer 324 provides an indication to data structure identifier 322 that specifies, for each identified operator, the combination of data structures generated thereby that resulted in an allocation of memory that was lower than the baseline memory allocation. In accordance with the examples shown above with reference to FIGS. 5A-5D, the indication may specify that the data structures generated by the first two instances of the softmax operator, the data structures generated by the first thirteen instances of the add operator, the data structures generated by the first five instances of the dropout operation, and the data structure generated by the first instance of the layer normalization operation are to be encoded. Data structure identifier 322 identifies the determined combinations based on the received indications from memory allocation analyzer 324 and causes the combination of data structures determined for each operation to be encoded. For instance, data structure identifier 322 generates a modified DNN computation graph 304D by adding nodes 306 to original DNN computation graph 304A. The newly added nodes 306 may define encode functions 310 for encoding the determined combination of data structures for each identified operator during a forward training pass of the DNN. The newly-added nodes 306 may also define decode functions 312 for decoding the encoded data structures during a backward training pass of the DNN. As described above, the type of encode functions and decode functions added to DNN computation graph 304A to generate the modified DNN computation graph 304D can be selected based upon on the specific layer pairs defined by DNN computation graph 304A. Modified DNN computation graph 304D is utilized to fully train the DNN while minimizing the memory footprint utilized during training and maximizing the batch size used for training.

In accordance with an embodiment, data structure identifier 322 performs additional analysis in which additional training sessions are performed, where each training session utilizes some of the combinations of encoded data structures determined for the identified operators. For instance, in accordance with the example described above, a first training session may be performed in which the first two data structures generated by instances of the softmax operation are encoded, the first thirteen data structures generated by instances of the add operator, and the data structures generated by the first five instances of the dropout operation are encoded (but the data structures generated by instances of the layer normalization operation are not encoded). A second training session may be performed in which the first thirteen data structures generated by instances of the add operator and the data structures generated by the first five instances of the dropout operation are encoded (but the data structures generated by instances of the softmax operation and the layer normalization operation are not encoded), and so on and so forth. Memory allocation analyzer 324 may determine whether any of these additional combinations of encoded data structures result in a more optimal allocation of memory. If memory allocation analyzer 324 determines that one of such combinations results in a more optimal allocation of memory, then memory allocation analyzer 324 may provide an indication to data structure identifier 322 indicating as such, and data structure identifier 322 generates a modified DNN computation graph in a similar manner as described above.

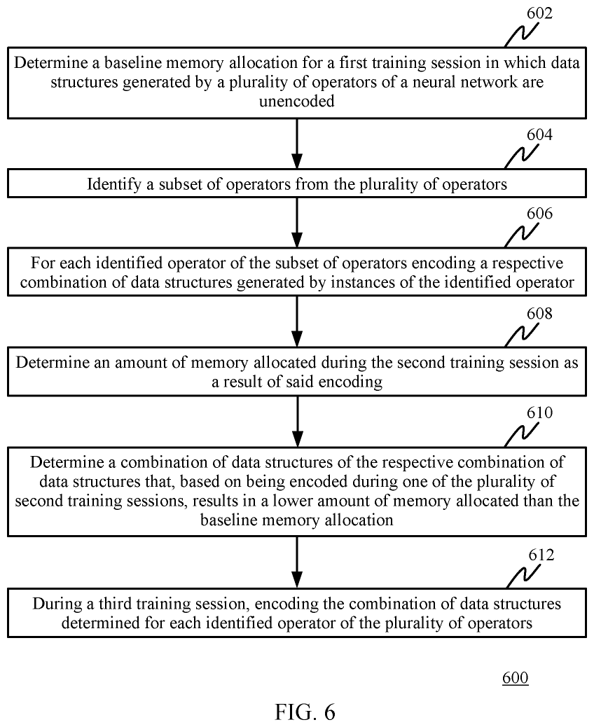

Accordingly, data structures generated during deep neural network training may be efficiently encoded in various ways. For example, FIG. 6 depicts a flowchart 600 of an example method for efficiently encoding data structures generated during deep neural network training in accordance with an example embodiment. In an embodiment, flowchart 600 may be implemented by system 300 of FIG. 3. Accordingly, the method of flowchart 600 will be described with continued reference to system 300 of FIG. 3, although the method is not limited to those implementations. Other structural and operational embodiments will be apparent to persons skilled in the relevant art(s) based on the discussion regarding flowchart 600 and system 300 of FIG. 3.

As shown in FIG. 6, the method of flowchart 600 begins at step 602. At step 602, a baseline memory allocation is determined for a first training session in which data structures generated by a plurality of operations of a neural network are unencoded. For example, with reference to FIG. 3, baseline memory allocation determiner 318 determines the baseline memory allocation for a first training session in which data structures generated by a plurality of operations of a neural network are unencoded. For instance, baseline memory allocation determiner 318 may provide DNN computational graph 304A to memory manager 316 and DNN runtime engine 314. DNN runtime engine 314 performs the training session based on DNN computational graph 304A and the memory allocated by memory manager 316. DNN runtime engine 314 may only perform a single iteration of the training session. After completion of the training session, baseline memory allocation determiner 318 may receive memory allocation information generated by memory manager 316. The memory allocation information may indicate the maximum amount of memory allocated during the training session.

In accordance with one or more embodiments, the plurality of operators comprises at least one of, a softmax operator, a transpose operator, a reshape operator, an add operator, an expand operator, a dropout operator, or a layer normalization operator.

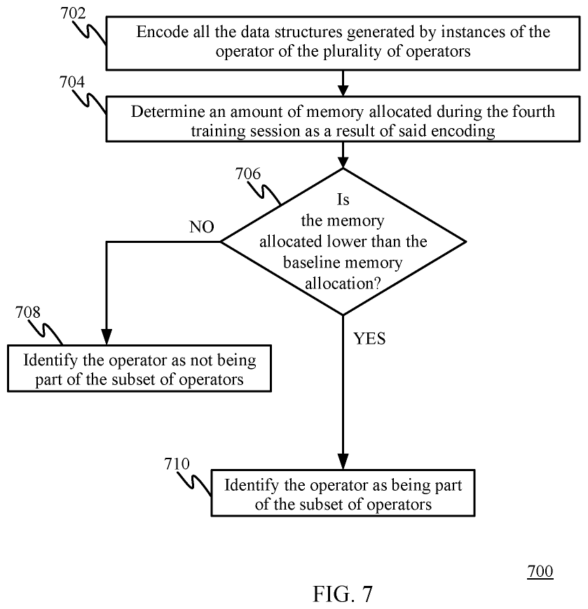

At step 604, a subset of operators from the plurality of operators are identified. For example, with reference to FIG. 3, operator identifier 320 determines a subset of operators from the plurality of operators. Additional details regarding identifying the operators are described below with reference to FIG. 7.

At step 606, for each identified operator of the subset of operators, during each second training session of a plurality of second training sessions, a respective combination of data structures generated by instances of the identified operator is encoded. For example, with reference to FIG. 3, data structure identifier 322, for each identified operator of the subset of operators, may generate a respective modified DNN computational graph 304C. Each generated modified DNN computational graph 304C comprises encode functions 310 that encode, during a respective second training session, a respective combination of data structures generated by instances of the corresponding identified operator. Operator identifier 320 may provide each DNN computational graph 304C to memory manager 316 and DNN runtime engine 314. DNN runtime engine 314 performs the training session for each DNN computational graph 304C and the memory allocated by memory manager 316 for the respective DNN computational graph 304C. DNN runtime engine 314 may only perform a single iteration of the training session for each respective DNN computational graph 304A.

At step 608, for each identified operator of the subset of operators, during each second training session of a plurality of second training sessions, an amount of memory allocated during the second training session as a result of said encoding is determined. For example, with reference to FIG. 3, memory manager 316 may generate memory allocation information for each second training session. The memory allocation information may indicate the maximum amount of memory allocated during each second training session. Operator identifier 320 receives the memory allocation information.

At step 610, for each identified operator of the subset of operators, a combination of data structures of the respective combination of data structures that, based on being encoded during one of the plurality of second training sessions, results in a lower amount of memory allocated than the baseline memory allocation is determined. For example, with reference to FIG. 3, memory allocation analyzer 324, for each identified operator of the subset of operators, determines a combination of data structures of the respective combination of data structures that, based on being encoded during one of the plurality of second training sessions, results in a lower amount of memory allocated than the baseline memory allocation.

At step 612, during a third training session, the combination of data structures determined for each identified operator of the plurality of operators is encoded. For example, with reference to FIG. 3, data structure identifier 322 may generate modified DNN computational graph 304D. Modified DNN computational graph 304D comprises encode functions 310 that encode, during the third training session, the combination of data structures determined for each identified operator of the plurality of operators. For example, with reference to FIGS. 5A-5D, encode functions 310 may encode the first two data structures generated by instances of the softmax operator, may encode the first thirteen data structures generated by instances of the add operator, may encode the first five data structures generated by instances of the dropout operator, and the first data structure generated an instance of the layer normalization operator. Data structure identifier 322 may provide DNN computational graph 304D to memory manager 316 and DNN runtime engine 314. DNN runtime engine 314 performs the training session for DNN computational graph 304D and the memory allocated by memory manager 316 for the DNN computational graph 304D. DNN runtime engine 314 performs a full training session (comprising a plurality of iterations) to train the DNN utilizing modified DNN computational graph 304D.

In accordance with one or more embodiments, the combination of data structures determined for each identifier operator of the plurality of operators are encoded during a forward pass of the third training session.

In accordance with one or more embodiments, during the third training session, the encoded combination of data structures determined for each identified operator of the plurality of operators are decoded during a backward pass of the third training session. For example, with reference to FIG. 3, modified DNN computational graph 304D comprises decode functions 312 that decode, during the third training session, the combination of data structures determined for each identified operator of the plurality of operators.

In accordance with one or more embodiments, the data structures generated by the instances of the identified operator comprise at least one of a feature map or a gradient map.

In accordance with one or more embodiments, the combination of data structures determined for each identified operator of the plurality of operators are encoded in accordance with at least one of a lossless-based compression technique or a lossy-based compression technique. For example, with reference to FIG. 3, encode functions 310 of modified DNN computational graph 304D may implement a lossless-based compression technique or a lossy-based compression technique.

FIG. 7 depicts a flowchart 700 of an example method for identifying a subset of identifiers in accordance with an example embodiment. In an embodiment, flowchart 700 may be implemented by system 300 of FIG. 3. Accordingly, the method of flowchart 700 will be described with continued reference to system 300 of FIG. 3, although the method is not limited to that implementation. Other structural and operational embodiments will be apparent to persons skilled in the relevant art(s) based on the discussion regarding flowchart 700 and system 300 of FIG. 3.

As shown in FIG. 7, the method of flowchart 700 begins at step 702. At step 702, during a fourth training session for each operator of the plurality of operators, all the data structures generated by instances of the operator of the plurality of operators are encoded. The fourth training session takes place after the first training session described with reference to step 602 and before the second training session described above with reference to step 606. For example, with reference to FIG. 3, operator identifier 320 may generate a modified DNN computational graph 304B for each operator. Each modified DNN computational graph 304B comprises encode functions 310 that encode, during the fourth training session, all the data structures generated for a respective operator. Operator identifier 320 may provide each DNN computational graph 304B to memory manager 316 and DNN runtime engine 314. DNN runtime engine 314 performs a training session for each DNN computational graph 304B and the memory allocated by memory manager 316 for the DNN computational graph 304B. For each respective DNN computational graph 304B, DNN runtime engine 314 may only perform a single iteration of a training session.

At step 704, an amount of memory allocated during the fourth training session as a result of said encoding is determined. For example, with reference to FIG. 3, after completion of each training session, operator identifier 320 may receive memory allocation information generated by memory manager 316. The memory allocation information may indicate the maximum amount of memory allocated during each training session.

At step 706, for each operator of the plurality of operators, a determination is made as to whether the amount of memory allocated as a result of encoding all the data structures generated by the instances of the operator is lower than the baseline memory allocation. If a determination is made that the amount of memory allocated as a result of encoding all the data structures generated by the instances of the operator is greater than or equal to the baseline memory allocation, flow continues to step 708. If a determination is made that the amount of memory allocated as a result of encoding all the data structures generated by the instances of the operator is lower than the baseline memory allocation, flow continues to step 710. For example, with reference to FIG. 3, memory allocation analyzer 324 determines whether the amount of memory allocated as a result of encoding all the data structures generated by the instances of the operator is lower than the baseline memory allocation generated by baseline memory allocation determiner 318. For instance, memory allocation analyzer 324 may compare the amount of memory allocated during each of the fourth training sessions to the baseline memory allocation.

At step 708, in response to determining that the amount of memory allocated as a result of encoding all the data structures generated by the instances of the operator is greater than or equal to the baseline memory allocation, the operator is identified as not being part of the subset of operators. For example, with reference to FIG. 3, operator identifier 320 identifies the operator as not being part of the subset of operators.

At step 710, in response to determining that the amount of memory allocated as a result of encoding all the data structures generated by the instances of the operator is lower than the baseline memory allocation, the operator is identified as being part of the subset of operators. For example, with reference to FIG. 3, operator identifier 320 identifies the operator as being part of the subset of operators.

### III. Example Mobile and Stationary Device Embodiments

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including in FIGS. 1-7, along with any modules, components and/or subcomponents thereof, as well as the flowcharts/flow diagrams described herein, including portions thereof, and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of mobile systems and computing devices provided herein are provided for purposes of illustration, and are not intended to be limiting. Embodiments may be implemented in further types of computer systems, as would be known to persons skilled in the relevant art(s).

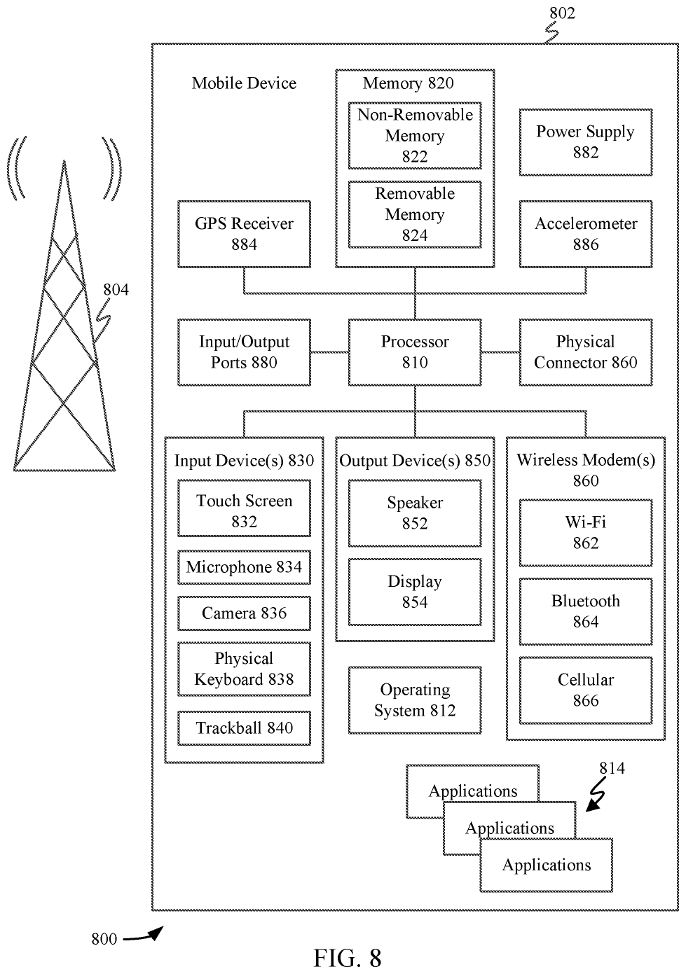

FIG. 8 is a block diagram of an exemplary mobile system 800 that includes a mobile device 802 that may implement embodiments described herein. For example, mobile device 802 may be used to implement any system, client, or device, or components/subcomponents thereof, in the preceding sections. As shown in FIG. 8, mobile device 802 includes a variety of optional hardware and software components. Any component in mobile device 802 can communicate with any other component, although not all connections are shown for ease of illustration. Mobile device 802 can be any of a variety of computing devices (e.g., cell phone, smart phone, handheld computer, Personal Digital Assistant (PDA), etc.) and can allow wireless two-way communications with one or more mobile communications networks 804, such as a cellular or satellite network, or with a local area or wide area network.

Mobile device 802 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components of mobile device 802 and provide support for one or more application programs 814 (also referred to as “applications” or “apps”). Application programs 814 may include common mobile computing applications (e.g., e-mail applications, calendars, contact managers, web browsers, messaging applications) and any other computing applications (e.g., word processing applications, mapping applications, media player applications).

Mobile device 802 can include memory 820. Memory 820 can include non-removable memory 822 and/or removable memory 824. Non-removable memory 822 can include RAM, ROM, flash memory, a hard disk, or other well-known memory devices or technologies. Removable memory 824 can include flash memory or a Subscriber Identity Module (SIM) card, which is well known in GSM communication systems, or other well-known memory devices or technologies, such as “smart cards.” Memory 820 can be used for storing data and/or code for running operating system 812 and application programs 814. Example data can include web pages, text, images, sound files, video data, or other data to be sent to and/or received from one or more network servers or other devices via one or more wired or wireless networks. Memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 820. These programs include operating system 812, one or more application programs 814, and other program modules and program data. Examples of such application programs or program modules may include, for example, computer program logic (e.g., computer program code or instructions) for implementing one or more of encoding plan determiner 102, DNN computational graph 104A, nodes 106, edges 108, modified DNN computational graph 104B, encode functions 110, decode functions 112, memory manager 116, DNN runtime engine 114, layer 202A, layer 202B, encoding plan determiner 302, DNN computational graph 304A, nodes 306, edges 308, modified DNN computational graphs 304B-304D, encode functions 310, decode functions 312, memory manager 316, DNN runtime engine 314, baseline memory allocation determiner 318, operator identifier 320, data structure identifier 322, memory allocation analyzer 324, along with any components and/or subcomponents thereof, as well as the flowcharts/flow diagrams described herein (e.g., flowchart 600 and/or flowchart 700), including portions thereof, and/or further examples described herein.

Mobile device 802 can support one or more input devices 830, such as a touch screen 832, a microphone 834, a camera 836, a physical keyboard 838 and/or a trackball 840 and one or more output devices 850, such as a speaker 852 and a display 854. Other possible output devices (not shown) can include piezoelectric or other haptic output devices. Some devices can serve more than one input/output function. For example, touch screen 832 and display 854 can be combined in a single input/output device. Input devices 830 can include a Natural User Interface (NUT).

One or more wireless modems 860 can be coupled to antenna(s) (not shown) and can support two-way communications between processor 810 and external devices, as is well understood in the art. Modem 860 is shown generically and can include a cellular modem 866 for communicating with the mobile communication network 804 and/or other radio-based modems (e.g., Bluetooth 864 and/or Wi-Fi 862). At least one wireless modem 860 is typically configured for communication with one or more cellular networks, such as a GSM network for data and voice communications within a single cellular network, between cellular networks, or between the mobile device and a public switched telephone network (PSTN).

Mobile device 802 can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components of mobile device 802 are not required or all-inclusive, as any components can be deleted and other components can be added as would be recognized by one skilled in the art.

In an embodiment, mobile device 802 is configured to implement any of the above-described features of flowcharts herein. Computer program logic for performing any of the operations, steps, and/or functions described herein may be stored in memory 820 and executed by processor 810.

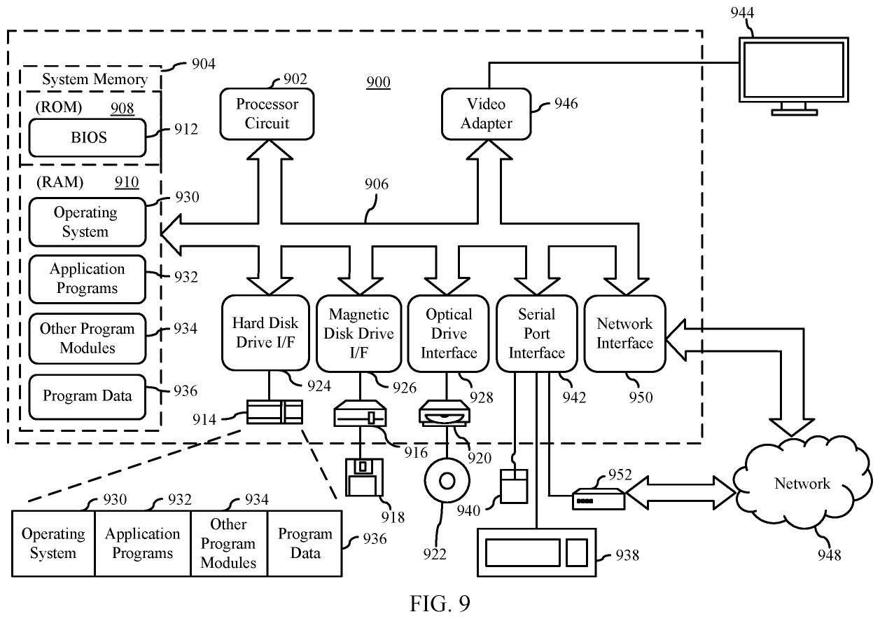

FIG. 9 depicts an exemplary implementation of a computing device 900 in which embodiments may be implemented. For example, embodiments described herein may be implemented in one or more computing devices similar to computing device 900 in stationary or mobile computer embodiments, including one or more features of computing device 900 and/or alternative features. The description of computing device 900 provided herein is provided for purposes of illustration, and is not intended to be limiting. Embodiments may be implemented in further types of computer systems and/or game consoles, etc., as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing embodiments described herein, including one or more of encoding plan determiner 102, DNN computational graph 104A, nodes 106, edges 108, modified DNN computational graph 104B, encode functions 110, decode functions 112, memory manager 116, DNN runtime engine 114, layer 202A, layer 202B, encoding plan determiner 302, DNN computational graph 304A, nodes 306, edges 308, modified DNN computational graphs 304B-304D, encode functions 310, decode functions 312, memory manager 316, DNN runtime engine 314, baseline memory allocation determiner 318, operator identifier 320, data structure identifier 322, memory allocation analyzer 324, along with any components and/or subcomponents thereof, as well as the flowcharts/flow diagrams described herein (e.g., flowchart 600 and/or flowchart 700), including portions thereof, and/or further examples described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium,” etc., are used to refer to physical hardware media. Examples of such physical hardware media include the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media (including memory 920 of FIG. 9). Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of embodiments discussed herein. Accordingly, such computer programs represent controllers of the computing device 900.

Embodiments are also directed to computer program products comprising computer code or instructions stored on any computer-readable medium or computer-readable storage medium. Such computer program products include hard disk drives, optical disk drives, memory device packages, portable memory sticks, memory cards, and other types of physical storage hardware.

### IV. Additional Exemplary Embodiments

A system is described herein. The system includes: at least one processor circuit; at least one memory that stores program code configured to be executed by the at least one processor circuit, the program code comprising: a baseline memory allocation determiner configured to determine a baseline memory allocation for a first training session in which data structures generated by a plurality of operators of a neural network are unencoded; an operator identifier configured to identify a subset of operators from the plurality of operators; a data structure identifier configured to, for each identified operator of the subset of operators: during each second training session of a plurality of second training sessions: encode a respective combination of data structures generated by instances of the identified operator; and determine an amount of memory allocated during the second training session; and a memory allocation analyzer configured to, for each identified operator of the subset of operators, determine a combination of data structures of the respective combination of data structures that, based on being encoded during one of the plurality of second training sessions, results in a lower amount of memory allocated than the baseline memory allocation, the data structure identifier further configured to during a third training session, encode the combination of data structures determined for each identified operator of the plurality of operators.

In an embodiment of the system, the combination of data structures determined for each identifier operator of the plurality of operators are encoded during a forward pass of the third training session.

In an embodiment of the system, the data structure identifier is further configured to: during the third training session, decode the encoded combination of data structures determined for each identified operator of the plurality of operators during a backward pass of the third training session.

In an embodiment of the system, the data structures generated by the instances of the identified operator comprise at least one of: a feature map; or a gradient map.

In an embodiment of the system, the operator identifier is configured to: during a fourth training session for each operator of the plurality of operators: encode all the data structures generated by instances of the operator of the plurality of operators; and determine an amount of memory allocated during the fourth training session as a result of said encoding; and for each operator of the plurality of operators: determine whether the amount of memory allocated as a result of encoding all the data structures generated by the instances of the operator is lower than the baseline memory allocation; in response to determining that the amount of memory allocated as a result of encoding all the data structures generated by the instances of the operator is lower than the baseline memory allocation, identify the operator as being part of the subset of operators; and in response to determining that the amount of memory allocated as a result of encoding all the data structures generated by the instances of the operator is greater than or equal to the baseline memory allocation, identify the operator as not being part of the subset of operators.

In an embodiment of the system, the combination of data structures determined for each identified operator of the plurality of operators are encoded in accordance with at least one of: a lossless-based compression technique; or a lossy-based compression technique.

In an embodiment of the system, the plurality of operators comprises at least one of: a softmax operator; a transpose operator; a reshape operator; an add operator; an expand operator; a dropout operator; or a layer normalization operator.

A method is also described herein. The method comprises: determining a baseline memory allocation for a first training session in which data structures generated by a plurality of operators of a neural network are unencoded; identifying a subset of operators from the plurality of operators; for each identified operator of the subset of operators: during each second training session of a plurality of second training sessions: encoding a respective combination of data structures generated by instances of the identified operator; and determining an amount of memory allocated during the second training session as a result of said encoding; and determining a combination of data structures of the respective combination of data structures that, based on being encoded during one of the plurality of second training sessions, results in a lower amount of memory allocated than the baseline memory allocation; and during a third training session, encoding the combination of data structures determined for each identified operator of the plurality of operators.

In an embodiment of the method, the combination of data structures determined for each identifier operator of the plurality of operators are encoded during a forward pass of the third training session.

In an embodiment of the method, the data structures generated by the instances of the identified operator comprise at least one of: a feature map; or a gradient map.

In an embodiment of the method, during a fourth training session for each operator of the plurality of operators: encoding all the data structures generated by instances of the operator of the plurality of operators; and determining an amount of memory allocated during the fourth training session as a result of said encoding; and for each operator of the plurality of operators: determining whether the amount of memory allocated as a result of encoding all the data structures generated by the instances of the operator is lower than the baseline memory allocation; and performing one of: in response to determining that the amount of memory allocated as a result of encoding all the data structures generated by the instances of the operator is lower than the baseline memory allocation, identifying the operator as being part of the subset of operators; or in response to determining that the amount of memory allocated as a result of encoding all the data structures generated by the instances of the operator is greater than or equal to the baseline memory allocation, identifying the operator as not being part of the subset of operators.

In an embodiment of the method, the combination of data structures determined for each identified operator of the plurality of operators are encoded in accordance with at least one of: a lossless-based compression technique; or a lossy-based compression technique.

In an embodiment of the method, the plurality of operators comprises at least one of: a softmax operator; a transpose operator; a reshape operator; an add operator; an expand operator; a dropout operator; or a layer normalization operator.

A computer-readable storage medium having program instructions recorded thereon that, when executed by a processor of a computing device, perform a method is also described herein. The method comprises: determining a baseline memory allocation for a first training session in which data structures generated by a plurality of operators of a neural network are unencoded; identifying a subset of operators from the plurality of operators; for each identified operator of the subset of operators: during each second training session of a plurality of second training sessions: encoding a respective combination of data structures generated by instances of the identified operator; and determining an amount of memory allocated during the second training session as a result of said encoding; and determining a combination of data structures of the respective combination of data structures that, based on being encoded during one of the plurality of second training sessions, results in a lower amount of memory allocated than the baseline memory allocation; and during a third training session, encoding the combination of data structures determined for each identified operator of the plurality of operators.

In an embodiment of the computer-readable storage medium, the combination of data structures determined for each identifier operator of the plurality of operators are encoded during a forward pass of the third training session.

In an embodiment of the computer-readable storage medium, the method further comprises: during the third training session, decoding the encoded combination of data structures determined for each identified operator of the plurality of operators during a backward pass of the third training session.

In an embodiment of the computer-readable storage medium, the combination of data structures determined for each identified operator of the plurality of operators are encoded in accordance with at least one of: a lossless-based compression technique; or a lossy-based compression technique.

In an embodiment of the computer-readable storage medium, the plurality of operators comprises at least one of: a softmax operator; a transpose operator; a reshape operator; an add operator; an expand operator; a dropout operator; or a layer normalization operator.

### V. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A system, comprising:
at least one processor circuit;
at least one memory that stores program code configured to be executed by the at least one processor circuit, the program code comprising:
a baseline memory allocation determiner configured to determine a baseline memory allocation for a first training session in which data structures generated by a plurality of operators of a neural network are unencoded;
an operator identifier configured to identify a subset of operators from the plurality of operators;
a data structure identifier configured to, for each identified operator of the subset of operators:
during each second training session of a plurality of second training sessions:
encode a respective combination of data structures generated by instances of the identified operator; and
determine an amount of memory allocated during the second training session; and
a memory allocation analyzer configured to, for each identified operator of the subset of operators, determine a combination of data structures of the respective combination of data structures that, based on being encoded during one of the plurality of second training sessions, results in a lower amount of memory allocated than the baseline memory allocation,
the data structure identifier further configured to during a third training session, encode the combination of data structures determined for each identified operator of the plurality of operators.

2. The system of claim 1, wherein the combination of data structures determined for each identifier operator of the plurality of operators are encoded during a forward pass of the third training session.

3. The system of claim 2, wherein the data structure identifier is further configured to:
during the third training session, decode the encoded combination of data structures determined for each identified operator of the plurality of operators during a backward pass of the third training session.

4. The system of claim 1, wherein the data structures generated by the instances of the identified operator comprise at least one of:
a feature map; or
a gradient map.

5. The system of claim 1, wherein the operator identifier is configured to:
during a fourth training session for each operator of the plurality of operators:
encode all the data structures generated by instances of the operator of the plurality of operators; and
determine an amount of memory allocated during the fourth training session as a result of said encoding; and
for each operator of the plurality of operators:
determine whether the amount of memory allocated as a result of encoding all the data structures generated by the instances of the operator is lower than the baseline memory allocation;
in response to determining that the amount of memory allocated as a result of encoding all the data structures generated by the instances of the operator is lower than the baseline memory allocation, identify the operator as being part of the subset of operators; and
in response to determining that the amount of memory allocated as a result of encoding all the data structures generated by the instances of the operator is greater than or equal to the baseline memory allocation, identify the operator as not being part of the subset of operators.

6. The system of claim 1, wherein the combination of data structures determined for each identified operator of the plurality of operators are encoded in accordance with at least one of:
a lossless-based compression technique; or
a lossy-based compression technique.

7. The system of claim 1, wherein the plurality of operators comprises at least one of:
a softmax operator;
a transpose operator;
a reshape operator;
an add operator;
an expand operator;
a dropout operator; or
a layer normalization operator.

8. A method, comprising:
determining a baseline memory allocation for a first training session in which data structures generated by a plurality of operators of a neural network are unencoded;
identifying a subset of operators from the plurality of operators;
for each identified operator of the subset of operators:
during each second training session of a plurality of second training sessions:
encoding a respective combination of data structures generated by instances of the identified operator; and
determining an amount of memory allocated during the second training session as a result of said encoding; and
determining a combination of data structures of the respective combination of data structures that, based on being encoded during one of the plurality of second training sessions, results in a lower amount of memory allocated than the baseline memory allocation; and
during a third training session, encoding the combination of data structures determined for each identified operator of the plurality of operators.

9. The method of claim 8, wherein the combination of data structures determined for each identifier operator of the plurality of operators are encoded during a forward pass of the third training session.

10. The method of claim 9, further comprising:
during the third training session, decoding the encoded combination of data structures determined for each identified operator of the plurality of operators during a backward pass of the third training session.

11. The method of claim 8, wherein the data structures generated by the instances of the identified operator comprise at least one of:
a feature map; or
a gradient map.

12. The method of claim 8, wherein said identifying comprises:
during a fourth training session for each operator of the plurality of operators:
encoding all the data structures generated by instances of the operator of the plurality of operators; and
determining an amount of memory allocated during the fourth training session as a result of said encoding; and
for each operator of the plurality of operators:
determining whether the amount of memory allocated as a result of encoding all the data structures generated by the instances of the operator is lower than the baseline memory allocation; and
performing one of:
in response to determining that the amount of memory allocated as a result of encoding all the data structures generated by the instances of the operator is lower than the baseline memory allocation, identifying the operator as being part of the subset of operators; or
in response to determining that the amount of memory allocated as a result of encoding all the data structures generated by the instances of the operator is greater than or equal to the baseline memory allocation, identifying the operator as not being part of the subset of operators.

13. The method of claim 8, wherein the combination of data structures determined for each identified operator of the plurality of operators are encoded in accordance with at least one of:
a lossless-based compression technique; or
a lossy-based compression technique.

14. The method of claim 8, wherein the plurality of operators comprises at least one of:
a softmax operator;
a transpose operator;
a reshape operator;
an add operator;
an expand operator;
a dropout operator; or
a layer normalization operator.

15. A computer-readable storage medium having program instructions recorded thereon that, when executed by a processor of a computing device, perform a method implemented by a browser application, the method comprising:
determining a baseline memory allocation for a first training session in which data structures generated by a plurality of operators of a neural network are unencoded;
identifying a subset of operators from the plurality of operators;
for each identified operator of the subset of operators:
during each second training session of a plurality of second training sessions:
encoding a respective combination of data structures generated by instances of the identified operator; and
determining an amount of memory allocated during the second training session as a result of said encoding; and
determining a combination of data structures of the respective combination of data structures that, based on being encoded during one of the plurality of second training sessions, results in a lower amount of memory allocated than the baseline memory allocation; and
during a third training session, encoding the combination of data structures determined for each identified operator of the plurality of operators.

16. The computer-readable storage medium of claim 15, wherein the combination of data structures determined for each identifier operator of the plurality of operators are encoded during a forward pass of the third training session.

17. The computer-readable storage medium of claim 16, the method further comprising:
during the third training session, decoding the encoded combination of data structures determined for each identified operator of the plurality of operators during a backward pass of the third training session.

18. The computer-readable storage medium of claim 15, wherein the data structures generated by the instances of the identified operator comprise at least one of:
a feature map; or
a gradient map.

19. The computer-readable storage medium of claim 15, wherein said identifying comprises:
during a fourth training session for each operator of the plurality of operators:
encoding all the data structures generated by instances of the operator of the plurality of operators; and
determining an amount of memory allocated during the fourth training session as a result of said encoding; and
for each operator of the plurality of operators:
determining whether the amount of memory allocated as a result of encoding all the data structures generated by the instances of the operator is lower than the baseline memory allocation; and
performing one of:
in response to determining that the amount of memory allocated as a result of encoding all the data structures generated by the instances of the operator is lower than the baseline memory allocation, identifying the operator as being part of the subset of operators; or
in response to determining that the amount of memory allocated as a result of encoding all the data structures generated by the instances of the operator is greater than or equal to the baseline memory allocation, identifying the operator as not being part of the subset of operators.

20. The computer-readable storage medium of claim 15, wherein the combination of data structures determined for each identified operator of the plurality of operators are encoded in accordance with at least one of:
a lossless-based compression technique; or
a lossy-based compression technique.
